(19) United States
(12) Patent Application Publication
(10) Pub. No.: US 2008/0109695 A1
(43) Pub. Date: May 8, 2008

(54) Method and apparatus for performing multi-input multi-output transmission in a multi-input multi-output user equipment in a wireless communications system

(75) Inventor: Yu-Chih Jen, Taipei City (TW)

Correspondence Address: BIRCH STEWART KOLASCH & BIRCH, PO BOX 747, FALLS CHURCH, VA, 22040-0747, US

(73) Assignee: Innovative Sonic Limited, Tortola (VG)

(21) Appl. No.: 11/979,693

(22) Filed: Nov. 7, 2007

Related U.S. Application Data
(60) Provisional application No. 60/857,187, filed on Nov. 7, 2006.
(60) Provisional application No. 60/864,962, filed on Nov. 8, 2006.
(60) Provisional application No. 60/857,803, filed on Nov. 9, 2006.

(51) Int. Cl. H04L 1/18; G06F 11/16

(52) U.S. Cl. 714/748; 714/E11.058

(57) ABSTRACT

A method for performing MIMO transmission in a UE capable of triggering at least one HARQ procedure in a wireless communications system is disclosed. The method includes selecting at least one HARQ process or at least one HARQ entity corresponding to a specified transmitter according to at least one transmission condition, and performing the MIMO transmission through the selected at least one HARQ process or the selected at least one HARQ entity.

### CROSS REFERENCE TO RELATED APPLICATIONS

This application claims the benefit of U.S. Provisional Application No. 60/857,187, filed on Nov. 7, 2006 and entitled “Method and Apparatus for Realizing Uplink HARQ Operation with MIMO Technology”, the benefit of U.S. Provisional Application No. 60/864,962, filed on Nov. 8, 2006 and entitled “Method and Apparatus for realizing Uplink HARQ operation with MIMO technology”, and the benefit of U.S. Provisional Application No. 60/857,803, filed on Nov. 9, 2006 and entitled “Method and Apparatus for realizing Uplink HARQ operation with MIMO technology”, the contents of which are incorporated herein by reference.

### BACKGROUND OF THE INVENTION

1. Field of the Invention

The present invention relates to a method and apparatus for performing multi-input multi-output transmission in a multi-input multi-output user equipment in a wireless communications system, and more particularly, to a method and apparatus for accurately performing multi-input multi-output transmission in the multi-input multi-output user equipment.

2. Description of the Prior Art

Multi-input and multi-output, or MIMO, refers to the use of multiple antennas both at the transmitter and receiver to improve the performance of a radio communications systems. MIMO technology has attracted attention in wireless communications, since it offers significant increases in data throughput and link range without additional bandwidth or transmit power.

Generally, MIMO technology can be classified into the following operating modes, including:

1. Spatial Multiplexing (SM): In the transmitter, a high rate signal is split into multiple lower rate streams and each stream is transmitted from a different antenna in the same frequency channel. SM is very powerful technique for increasing channel capacity at higher Signal to Noise Ratio (SNR).

2. Transmit Diversity (TD, or named spatial diversity): A single stream is received or transmitted though multiple paths established by multiple antennas, so that transmission quality can be enhanced.

3. Beamforming: When receiving a signal, beamforming can increase the receiver sensitivity in the direction of wanted signals and decrease the sensitivity in the direction of interference and noise. When transmitting a signal, beamforming can increase the power in the direction the signal is to be sent.

The above-mentioned operating modes can be used in coordination.

A new mobile communications system, such as Long Term Evolution (LTE) wireless communications system, is an advanced high-speed wireless communications system established upon the 3G mobile telecommunications system, and uses technologies of High Speed Downlink Package Access (HSDPA) and High Speed Uplink Package Access (HSUPA), to increase bandwidth utility rate and package data processing efficiency to improve uplink/downlink (UL/DL) transmission rate. HSDPA and HSUPA adopt Hybrid Automatic Repeat Request (HARQ) technology to enhance retransmission rate and reduce transmission delay. HARQ is a technology combining Feed-forward Error Correction (FEC) and ARQ methods, and uses a “Multi-channel Stop and Wait” algorithm, meaning that each channel decides to retransmit a packet or transmit the next packet according to positive/negative acknowledgement signals (ACK/NACK) reported by the receiver.

The LTE system can reach high transmission speed and large channel capacity under a limited frequency spectrum. Such operation requires high bandwidth utility rate. Therefore, the prior art has introduced MIMO into LTE, so as to multiply channel capacity without additional bandwidth or transmit power.

Due to MIMO, since transport blocks (data or control message) will be processed by different HARQ entities, the number of HARQ entities can be multiplied (depending on how many antennas). It means that each HARQ entity shall maintain its own transmission attributes (i.e. the Resource unit (RU) allocation, Modulation, coding and transport block size, and duration of the retransmission) being coincide or different, and HARQ operation may be affected based on what kind of MIMO mode it applies. In addition, the synchronous HARQ operation at UL is temporarily assumed while adaptive and asynchronous features are For Further Study (FFS).

On the other hand, in UL, due to the transport block characteristic, transmission resource and system load, transmission frequency, and importance and so on, it's expected that different MIMO mode would be utilized. This would determine different behavior at resource (grant) allocation by Scheduling Information (SI) messages, which are transmitted from the network, and utilized for indicating the granted transmission resources for UL transmission of user equipments (UEs). Moreover, in response to data transmission, transmission of control signaling may require different MIMO mode and resources as well as thus handling in various ways to provide necessary information.

However, different MIMO modes are not permissibly used for different UEs simultaneously in UL multi-user MIMO (MU-MIMO).

### SUMMARY OF THE INVENTION

According to the present invention, a method for performing MIMO transmission in a UE capable of triggering at least one HARQ procedure in a wireless communications system is disclosed. The method comprises selecting at least one HARQ process or at least one HARQ entity corresponding to a specified transmitter according to at least one transmission condition, and performing the MIMO transmission through the selected at least one HARQ process or the selected at least one HARQ entity.

According to the present invention, a communications device for accurately performing MIMO transmission in a wireless communications system. The communications device is capable of triggering at least one HARQ procedure, and comprises a control circuit for realizing functions of the communications device, a processor installed in the control circuit, for executing a program code to command the control circuit, and a memory installed in the control circuit and coupled to the processor for storing the program code. The program code comprises selecting at least one HARQ process or at least one HARQ entity corresponding to a specified transmitter according to at least one transmission condition, and performing the MIMO transmission through the selected at least one HARQ process or the selected at least one HARQ entity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 is a flowchart of a process according to an embodiment of the present invention.

### DETAILED DESCRIPTION

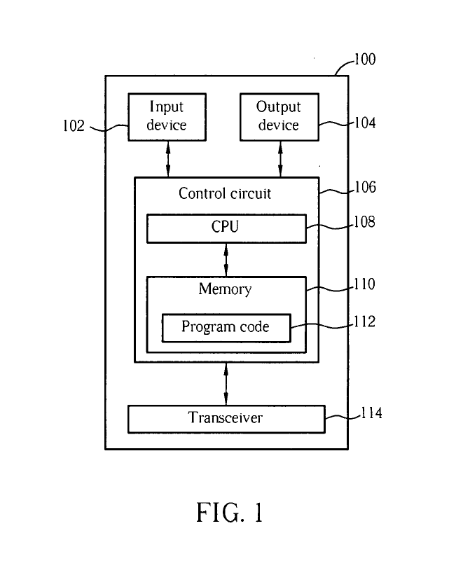

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

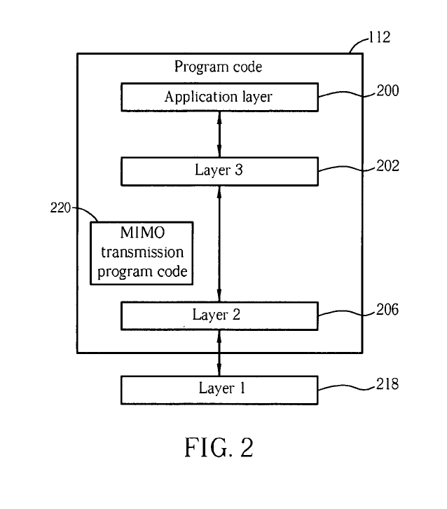

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1218. The Layer 3 202 performs resource control, the Layer 2 206 performs link control, and the Layer 1218 performs physical connections.

As mentioned above, MIMO has been included in LTE, to multiply channel capacity without additional bandwidth or transmit power. In such case, the embodiment of the present invention provides a MIMO transmission program code 220 in the program code 112, utilized for realizing MIMO transmission in LTE.

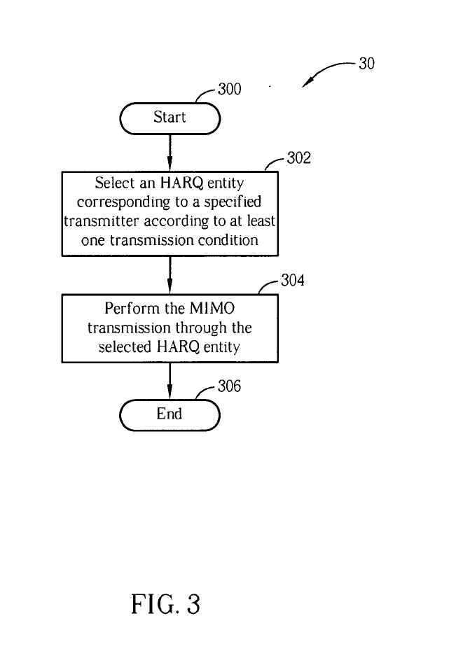

Please refer to FIG. 3, which illustrates a flowchart of a process 30 in accordance with an embodiment of the present invention. The process 30 is utilized for performing MIMO transmission in a MIMO UE, and can be compiled into the MIMO transmission program code 220. The process 30 comprises the following steps:
Step 300: Start.
Step 302: Select an HARQ entity corresponding to a specified transmitter according to at least one transmission condition.
Step 304: Perform the MIMO transmission through the selected HARQ entity.
Step 306: End.

According to the process 30, when performing MIMO transmission, the embodiment of the present invention selects an HARQ entity corresponding to a specified transmitter for the MIMO transmission based on at least one transmission condition.

Preferably, in the embodiment of the present invention, the UE comprises a plurality of antennas, one of which is the specified transmitter. Correspondingly, in step 302, the selected HARQ entity is selected from a plurality of HARQ entities. Besides, the transmission condition can be established according to service requirement or traffic quality requirement.

Furthermore, in the embodiment of the present invention, the UE can group (reduce to one) or combine (concatenate as a whole) the plurality of HARQ entities into an integrated HARQ entity according to a transmission status, such as traffic type, data content, system load, buffer status, uplink resource, channel and transmission condition, or application. In addition, each of the plurality of HARQ entities is either synchronous or non-synchronous, or adaptive or non-adaptive at downlink and uplink.

If an HARQ entity includes a specified number of HARQ processes, the number of HARQ entities should be increased as transmission capability changes, to meet the parallel operation. Oppositely, if a plurality of transmissions are allowed in an HARQ entity, then a plurality of HARQ entities are unnecessary. That is, as long as at least one HARQ process can be handled in a TTI, one or more HARQ entities are permissible.

Moreover, in the embodiment of the present invention, the UE can schedule preemption of new transmission or retransmission by scheduling the preemption transport block into the HARQ entity according to previous schedule, multiplexing, HARQ class, traffic attributes of processes, priority, or MIMO mode.

In summary, when performing MIMO transmission, the embodiment of the present invention selects an HARQ entity corresponding to a specified transmitter for the MIMO transmission based on at least one transmission condition. Therefore, via the embodiment of the present invention, MIMO UE can accurately perform MIMO transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing multiple-input and multiple-output, called MIMO hereinafter, transmission in a user equipment capable of triggering at least one hybrid automatic repeat request, called HARQ hereinafter, procedure in a wireless communications system, the method comprising:
selecting at least one HARQ process or at least one HARQ entity corresponding to a specified transmitter according to at least one transmission condition; and
performing the MIMO transmission through the selected at least one HARQ process or the selected at least one HARQ entity.

2. The method of claim 1, wherein the specified transmitter is one of a plurality of antennas.

3. The method of claim 1, wherein the at least one transmission condition comprises service requirement.

4. The method of claim 1, wherein the at least one transmission condition comprises traffic quality requirement.

5. The method of claim 1, wherein selecting the at least one HARQ process or the at least one HARQ entity corresponding to the specified transmitter according to the at least one transmission condition is selecting the at least one HARQ process corresponding to the specified transmitter from a plurality of HARQ processes or selecting the at least one HARQ entity corresponding to the specified transmitter from a plurality of HARQ entities.

6. The method of claim 1 further comprising integrating the plurality of HARQ processes or the plurality of HARQ entities into an integrated HARQ entity.

7. The method of claim 6, wherein integrating the plurality of HARQ entities into the integrated HARQ entity is grouping or combining the plurality of HARQ entities to one HARQ entity according to a transmission status, so as to generate the integrated HARQ entity.

8. The method of claim 7, wherein the transmission status comprises a traffic type, data content, system load, buffer status, uplink resource, channel and transmission condition, or application.

9. The method of claim 6 further comprising performing independent synchronization respectively with each of the plurality of HARQ entities.

10. The method of claim 6, wherein each of the plurality of HARQ entities or each of the plurality of HARQ processes is either synchronous or non-synchronous at downlink and uplink.

11. The method of claim 6, wherein each of the plurality of HARQ entities or each of the plurality of HARQ processes is either adaptive or non-adaptive at downlink and uplink.

12. The method of claim 1, wherein selecting the HARQ entity corresponding to the specified transmitter according to the at least one transmission condition comprises scheduling preemption of new transmission or retransmission by scheduling the preemption transport block into the HARQ entity according to the at least one transmission condition comprising previous schedule, multiplexing, HARQ class, traffic attributes of processes, priority, or MIMO mode.

13. A communications device for accurately performing multi-input multi-output, called MIMO hereinafter, transmission in a wireless communications system, the communications device capable of triggering at least one hybrid automatic repeat request, called HARQ hereinafter, the communications device comprising:
a control circuit for realizing functions of the communications device;
a processor installed in the control circuit, for executing a program code to command the control circuit; and
a memory installed in the control circuit and coupled to the processor for storing the program code;
wherein the program code comprises:
selecting at least one HARQ process or at least one HARQ entity corresponding to a specified transmitter according to at least one transmission condition; and
performing the MIMO transmission through the selected at least one HARQ process or the selected at least one HARQ entity.

14. The communications device of claim 13, wherein the specified transmitter is one of a plurality of antennas.

15. The communications device of claim 13, wherein the at least one transmission condition comprises service requirement.

16. The communications device of claim 13, wherein the at least one transmission condition comprises traffic quality requirement.

17. The communications device of claim 13, wherein selecting the at least one HARQ process or the at least one HARQ entity corresponding to the specified transmitter according to the at least one transmission condition is selecting the at least one HARQ process corresponding to the specified transmitter from a plurality of HARQ processes or selecting the at least one HARQ entity corresponding to the specified transmitter from a plurality of HARQ entities.

18. The communications device of claim 14, wherein the program code further comprises integrating the plurality of HARQ processes or the plurality of HARQ entities into an integrated HARQ entity.

19. The communications device of claim 18, wherein integrating the plurality of HARQ entities into the integrated HARQ entity is grouping or combining the plurality of HARQ entities to one HARQ entity according to a transmission status, so as to generate the integrated HARQ entity.

20. The communications device of claim 19, wherein the transmission status comprises a traffic type, data content, system load, buffer status, uplink resource, channel and transmission condition, or application.

21. The communications device of claim 18, wherein the program code further comprises performing independent synchronization respectively with each of the plurality of HARQ entities.

22. The communications device of claim 18, wherein each of the plurality of HARQ entities or each of the plurality of HARQ processes is either synchronous or non-synchronous at downlink and uplink.

23. The communications device of claim 18, wherein each of the plurality of HARQ entities or each of the plurality of HARQ processes is either adaptive or non-adaptive at downlink and uplink.

24. The communications device of claim 13, wherein selecting the HARQ entity corresponding to the specified transmitter according to the at least one transmission condition comprises scheduling preemption of new transmission or retransmission by scheduling the preemption transport block into the HARQ entity according to the at least one transmission condition comprising previous schedule, multiplexing, HARQ class, traffic attributes of processes, priority, or MIMO mode.
